(19) United States
(12) Patent Application Publication
(10) Pub. No.: US 2020/0158083 A1
(43) Pub. Date: May 21, 2020

(54) VIBRATION DAMPING OF A WIND TURBINE TOWER

(71) Applicant: Wobben Properties GmbH, Aurich (DE)

(72) Inventors: Maik NITSCHE, Schortens (DE); Alexander BÜSCHEL, Hamburg (DE); Jörg SCHÜLLER, Aurich (DE); Steffen RÖTHEL, Emden (DE)

(21) Appl. No.: 16/604,739

(22) PCT Filed: Apr. 11, 2018
(86) PCT No.: PCT/EP2018/059293

§ 371 Date: Oct. 11, 2019

(30) Foreign Application Priority Data
Apr. 12, 2017 (DE) 10 2017 107 912.2

(51) Int. Cl. F03D 7/02; F03D 13/20; F16M 13/02; F16F 7/116

(52) U.S. Cl. CPC F03D 7/0296; F03D 13/20; F16M 13/02; F16F 7/116; F05B 2240/912; F16F 2224/02; F16F 2228/08; F16F 2222/08; F16F 2234/02; F16F 2234/04; F05B 2260/964

(57) ABSTRACT

A coupling element prepared for fastening between a oscillatory body and a tower wall of a tower of a wind turbine in order to influence relative motion between the oscillatory body and the tower wall in order to thereby influence vibration behavior of the tower, comprising a first fastening section for fastening to the oscillatory body and a second fastening section for fastening to the tower wall in order to establish mechanical coupling between the oscillatory body and the tower wall via the coupling element, the coupling permitting relative motion between the oscillatory body and the tower wall, and the relative motion having a first motion direction, in the case of which the first and second fastening sections move toward each other, and a second motion direction, in the case of which the first and second fastening sections move away from each other, and the coupling element having a spring element for spring-elastic coupling between the first and second fastening sections, the spring-elastic coupling being described by a spring function and the spring element being designed in such a way that the spring function is substantially the same for the first and second motion directions and additionally or alternatively the spring element being designed in such a way that motion in the first motion direction leads to compression of a first spring section and to extension of a second spring section in the spring element and motion in the second motion direction leads to extension of the first spring section and to compression of the second spring section in the spring element in order to thereby match the respective spring functions for the first and second motion directions to each other.

### BACKGROUND

### Technical Field

The present invention relates to a coupling element for fastening between a vibratory body and a tower wall of a tower of a wind turbine. The present invention furthermore relates to a tower of a wind turbine having a vibratory apparatus for influencing a vibration of the tower. The present invention furthermore relates to a vibratory apparatus which is designed for use in a tower of a wind turbine in order to influence a vibration of the tower. The present invention furthermore relates to a method for influencing a tower vibration. The present invention furthermore relates to a wind turbine.

### Description of the Related Art

Wind turbines are generally known, and modern wind turbines have a wind turbine tower on which a nacelle is arranged. The nacelle has a rotor with rotor blades in order to thus obtain electrical energy from wind. In particular during operation, the wind acts on said rotor blades but partially also on the nacelle and the tower, and the wind can also lead to a vibration of the wind turbine, in particular of the tower of the wind turbine. The rotation of the rotor can also lead to, or influence, a vibration of the tower. In the worst case, depending on tower natural frequencies, resonance situations can arise at particular rotor rotational speeds. In the theoretically worst case, this can lead to a resonance catastrophe.

Such vibration problems can be counteracted by means of a corresponding tower construction. One possibility is to construct the tower to be so solid or rigid that it exhibits practically no or no significant vibration. Such a construction is however generally associated with very high outlay, in particular outlay in terms of materials.

Other, more modern approaches propose a tower construction which is such that resonance frequencies do not coincide with operating points of the wind turbines at which rotational speeds arise which can induce such resonance frequencies or can correspond to such resonance frequencies. Such solutions are then generally coordinated with the installation controller, in particular such that the installation controller implements control so as to pass through any resonance points with the rotational speed as quickly as possible, for example during the start-up of the wind turbine.

The construction of such towers, too, can however entail increased outlay. Furthermore, such a solution restricts the operating range of the wind turbine.

Solutions have basically also been proposed for equipping a wind turbine with an absorber system in its tower, which absorber system is designed to dampen such tower vibrations. Such absorber systems are however cumbersome and often unsophisticated and can furthermore be highly obstructive in the tower interior. In particular, pendulum dampers suspended centrally in the tower may in particular collide with central cable guides and other elements arranged there. Required structural space may generally not be present in particular for the introduction of large vibratory masses, which may be realized by means of water introduced into the vibratory bodies. The pendulum movement may also exhibit an unfavorable movement component.

Likewise, solutions have already been proposed in which, in the nacelle, by means of corresponding pipe systems, liquid damper systems are intended to achieve vibration damping. Here, liquids, in particular water, can be moved, in particular pumped, such that it can counteract a vibration movement. Such a system, too, is highly complex and, here, there is also the problem that the force counteracting the tower vibration must be transmitted from the nacelle to the tower, that is to say can give rise to a load on an azimuth bearing.

Furthermore, the German laid-open specification DE 10 2012 222 191 A1 has disclosed a vibration absorber module in the case of which pendulum spring elements are used which run in the direction of a suspension axis of a pendulum system used therein.

In the priority application relating to the present application, the German Patent and Trade Mark Office performed a search on the following prior art: DE 198 56 500 A1 and DE 10 2012 222 191 A1.

### BRIEF SUMMARY

The present invention relates to a coupling element for fastening between a vibratory body and a tower wall of a tower of a wind turbine in order to influence a relative movement between the vibratory body and the tower wall in order to thus influence a vibration characteristic of the tower.

Provided is a method to counteract vibration problems of a tower of a wind turbine in a simple manner, in particular in a simple manner in terms of construction, and in particular in a passive manner.

A coupling element is proposed. The coupling element is designed for fastening between a vibratory body and a tower wall of a tower of a wind turbine. Said coupling element is intended to influence a relative movement between the vibratory body and the tower wall. It is sought to realize this to such a degree that a vibration characteristic of the tower can be influenced in this way. The coupling element and correspondingly also the vibratory body to which said coupling element is fastened by way of one portion are thus also dimensioned such that a vibration characteristic, including a vibration of the tower, can be influenced, that is to say in particular can be significantly influenced.

For this purpose, the coupling element has a first and a second fastening portion. The first fastening portion is fastened to the vibratory body, and the second is fastened to the tower wall. In this way, a mechanical coupling is produced between the vibratory body and the tower wall via the coupling element. Thus, if the vibratory body vibrates relative to the tower wall at this location, that is to say a relative movement between tower wall and vibratory body occurs there, said relative movement correspondingly occurs between the first and second fastening portions.

Here, it is basically the case that multiple such coupling elements, for example six or more coupling elements, to name just one example, are provided for one tower and one vibratory body.

The coupling thus permits a relative movement between vibratory body and tower wall, and said relative movement has a first and a second movement direction. In the case of the first movement direction, the first and second fastening portions move toward one another, whereas said first and second fastening portions move away from one another in the case of the second movement direction. The definition of the first and second movement directions may basically also be reversed. In any case, these two movement directions are to be understood as being directed oppositely to one another. It is not the case that these are directed transversely with respect to one another.

Furthermore, a spring means is provided which realizes resiliently elastic coupling between the first and second fastening portions and thus realizes resiliently elastic coupling between the tower wall and the vibratory body when the coupling element is installed. The resiliently elastic coupling can be described by a spring function. The spring means is designed such that the first movement in the spring means leads to a compression of a first spring portion and an extension of a second spring portion. Furthermore, the spring means is designed such that the second movement in the spring means leads to an extension of the first spring portion and to a compression of the second spring portion. Thus, two spring portions are provided, of which it is always the case that one is compressed and the other is extended. In the case of a reversed movement direction, this function is also reversed, such that then, the compressed spring portion is extended again, and the extended spring portion is compressed.

This functionality by means of said two spring portions is in this case configured such that the spring function for the first and second movement directions are as far as possible equalized with one another.

In particular, a spring variant in the case of which one movement direction extends a spring and the reverse movement direction compresses said spring is thus improved, as a result of which both direction-dependent and deflection-amplitude-dependent spring functions can generally be realized. The proposal of said two spring portions thus realizes uniformity of said spring function and thus uniformity of the mechanical coupling of said coupling element in its use between the tower wall and the vibratory body.

It is thus sought for the spring function to be substantially equal in both movement directions. It also conforms to the concept if it is achieved in some other way that the spring function is substantially equal for the first and second movement directions.

The coupling element is preferably formed as a spring-damper element and has, aside from the spring means, a damping portion for coupling with damping action between the first and second fastening portions. Said coupling with damping action can be described by a damping function. For this purpose, it is proposed that the damping function is substantially equal for the first and second movement directions. Uniformity can thus be achieved for the damping also, such that the first and second movements are influenced equally, that is to say symmetrically.

It is preferably the case that the spring function is not only substantially equal in both movement directions but also substantially linear. The spring force of the entire spring means, that is to say the sum of the spring forces of the first and second spring portions, is thus, in terms of magnitude, substantially proportional to a deflection out of a central position or a rest position.

It is preferably also the case that the damping function is not only substantially equal in the first and second movement directions but also substantially linear. The damping force, which opposes the movement, of the damping portion is thus, in terms of magnitude, substantially proportional to a speed of the relative movement between the first and second fastening portions, that is to say to a relative movement between vibratory body and tower wall.

In this way, in particular if both the spring function and the damping function are linear, it is possible to achieve damping, in particular damping with an invariant damping constant, of a vibration of the tower dynamics or of the movement dynamics of the wind turbine as a whole.

A linear characteristic of the spring function may be achieved in particular by means of a prestress of both spring portions. It is self-evidently possible to realize a linear spring function only for a predetermined design travel in the case of which the coupling element and in particular the spring means does not reach a stop. It is thus proposed that the spring function is substantially linear for the predetermined design travel.

For the damping function, linearity and symmetry can be achieved in particular by means of a symmetrical design.

In one embodiment, it is proposed that the coupling element has a first and a second anchor portion, which are fixedly connected to one another. Furthermore, between the first and second anchor portions, there is arranged a central portion which is movable relative to said two anchor portions. Here, the first or second anchor portion is fixedly connected to the second fastening portion, and the central portion is fixedly connected to the first fastening portion. The central portion can thus move between the two anchor portions and can thus move together with the vibratory body between the two anchor portions and thus relative to the tower wall. The relative movement between vibratory body and tower wall thus corresponds to the movement of the central portion between the anchor portions.

In this way, it is in particular also possible in a simple manner to realize the uniform division of the spring means into two spring portions.

Preferably, here, the spring means has a first spring between the central portion and the first anchor portion and a second spring between the central portion and the second anchor portion. Here, the first spring forms the first spring portion and the second spring forms the second spring portion. It is preferable for both springs to be identical. The springs may be formed for example as helical springs.

It is preferable for the first and second springs to be prestressed in order to achieve that neither of the two springs reaches or overshoots a relaxed state during the movement of the coupling element. In particular, the two springs may be clamped between the central portion and the first anchor portion and between the central portion and the second anchor portion respectively. Said prestress is preferably of such an intensity that, even in the case of compression of the first spring as far as a stop, at which said first spring can be compressed no further, the second spring is still under stress, that is to say is still prestressed. Equally, it conversely also applies that, specifically, the first spring is still under stress, and thus still prestressed, when the second spring has been fully compressed, that is to say has reached a stop. Here, the situation relates to one of the two springs having been compressed as far as a stop, no longer to the normal operating range. In other words, the coupling element is intended for use in the case of which the described maximum compression is not reached.

Spacing between the first and second anchor portions is preferably adjustable in order to thereby adjust the prestress.

Preferably, an adjusting means actuated by means of an actuator is provided for this purpose, such that an online adjustment is also possible. It is thus possible, as necessary, to react to minimal changes in the vibration characteristics of the tower, which may also be caused by changes to the other elements of the wind turbine.

In a further embodiment, it is proposed that the damping portion is fastened between the central portion and the first anchor portion, or between the central portion and the second anchor portion. Here, it has been recognized in particular that even a damping function which is symmetrical in both movement directions, and also a linear damping function, can be realized by means of a single damping portion, which in this case is arranged between the two portions which move relative to one another. Alternatively, between the central portion and each of the two anchor portions, there may be provided in each case one damping portion, which damping portions are in particular identical, or at least have the same characteristics. In this way, it can be ensured that the damping is equal in both movement directions.

A tower of a wind turbine is also proposed. Such a tower has a tower central axis and a tower wall from which the tower is substantially constructed. Furthermore, a vibratory apparatus is provided for influencing a vibration of the tower. The vibratory apparatus has a vibratory body which is suspended in the tower so as to be spaced apart from the tower wall. Accordingly, said vibratory body is suspended in the tower interior and can basically also vibrate there relative to the tower wall in various directions. The vibratory body may basically be arranged in the tower in some manner other than by suspension, for example by means of a bearing arrangement which permits substantially a movement in any desired directions in a plane perpendicular to the tower central axis.

Here, the vibratory body is to be suspended, or mounted in some other way, so as to be spaced apart from the tower wall such that sufficient space remains for the vibratory body to be able to perform a movement relative to the tower.

Furthermore, a coupling element is fastened between the vibratory body and the tower wall in order to influence a relative movement between the vibratory body and the tower wall. It is preferable for multiple coupling elements, in particular four, six or eight coupling elements, to be provided. In particular, said coupling elements are structurally identical and distributed uniformly over the circumference of the vibratory body. In particular, the use of six coupling elements creates a good uniform distribution over the circumference of the vibratory body, at the same time without excessive outlay in terms of material, such that six coupling elements are particularly preferred.

Provision is furthermore made for the vibratory body to be formed so as to be hollow along a vertical central axis. In particular, said vibratory body is formed so as to be hollow along the tower central axis. By means of this hollow form, it is achieved that the vibratory body does not obstruct apparatuses in the tower such as for example a personnel or equipment elevator. Thus, the vibratory body is preferably of hollow form such that sufficient space remains for a personnel elevator of a wind turbine to be able to extend vertically and centrally through the vibratory body.

It has also been recognized that a very great mass can be accommodated in an externally situated shell. It is thus possible to realize a vibratory body which has a large mass and which nevertheless leaves sufficient space in the tower for other required apparatuses.

The vibratory body is preferably formed substantially as a hollow truncated cone or as a hollow cylinder. In this way, it is possible for a large mass of the vibratory body to be accommodated in said hollow truncated cone or hollow cylinder in a simple and uniform manner. Basically, a hollow cylinder is proposed, but a correspondingly conical shape of the shell may also be proposed for adaptation to a conical shape of the tower, such that the stated hollow truncated cone is proposed for this purpose.

Optionally, a hollow truncated cone of said type has a vertical aperture in the casing in order to provide space for a tower ladder arranged at the inside on the tower wall, such that service personnel can climb up and down along this tower ladder in the tower and, in so doing, can pass the vibratory body in the region of the aperture.

For example, the hollow cylinder or hollow truncated cone may have the aperture in a range of approximately 60 degrees in relation to 360 degrees of an entire circumference. Somewhat larger or smaller ranges may also be considered, and the aperture is preferably provided in a range of a size of 30 to 90 degrees.

In particular with a value of the aperture of 60 degrees, it is still possible for six coupling elements to be arranged so as to be distributed uniformly over the circumference. A value of 90 degrees is particularly preferably proposed for a variant with four coupling elements. A value of 30 degrees is proposed in particular in the case of large tower diameters. Even then, it is still possible for a member of service personnel to pass the vibratory body in the region of its aperture when climbing a ladder arranged there. Through the definition of the aperture in terms of a degree range in relation to the 360 degree circumference, it is possible in any case to provide a sufficient aperture which can provide sufficient space even in the case of an only small central cavity. It is preferable for an even number of coupling elements to be proposed, wherein the coupling elements are distributed uniformly around the circumference of the vibratory body. 10° is proposed as a smallest value for the aperture.

In one embodiment, it is proposed that the vibratory body has a casing which encircles the central axis with an aperture. Here, provision is made whereby the wall thickness of said encircling casing varies in a circumferential direction. The wall thickness varies such that the vibratory body, despite the aperture, has a center of gravity in the central axis. The central axis is oriented vertically and is in this case in a geometrical center of the vibratory body. In particular, said central axis is the central axis in relation to the outer contour of the vibratory body. Furthermore or alternatively, said central axis corresponds, in the rest state of the vibratory body and of the tower, to the tower central axis.

To influence the vibration of the tower, in particular for simultaneous damping, the center of mass of the vibratory body is, in the rest state, in the tower central axis. Owing to the aperture provided in the shell of the vibratory body, the center of mass would be displaced in the case of a wall thickness which is uniform in the circumferential direction. This can be compensated by means of the proposed variation of the wall thickness of the vibratory body. By means of a correspondingly uniformly distributed variation of the wall thickness of the vibratory body, the center of gravity can be positioned in the tower central axis or the central axis of the vibratory body despite the aperture. In this way, it is also possible, for example, to avoid the provision of additional balancing weights.

The vibratory body is preferably suspended so as to be spaced apart from the tower wall centrally with a mean wall spacing, wherein the wall spacing is in each case smaller than ¼ of a tower inner diameter in the respective region. In particular, said wall spacing is in each case smaller than ⅛ of said tower inner diameter. It is achieved in this way that said vibratory body is extremely close to the tower wall and thus itself has a relatively large diameter. In this way, it is also possible for the vibratory body to have a correspondingly large volume and thus a correspondingly large significant mass in order to be able to also significantly influence the tower in terms of its vibration characteristics. Said spacing, which is less than ¼ or preferably even less than ⅛ of the tower inner diameter at said location, still leaves sufficient space for relative movements between the vibratory body and the tower wall. The spacing is preferably greater than 1/20 of the tower inner diameter. This prevents said space between the vibratory body and the tower wall being selected to be too small.

The vibratory body preferably has a height which corresponds to at least half of its diameter, preferably to at least the value of its diameter, and which is preferably at least twice its diameter. In this way, it is possible overall to provide a very high mass for the vibratory body. All of these solutions nevertheless permit good utilization of the tower interior space for example for cable guides or, if appropriate, an elevator.

In one embodiment, it is proposed that the vibratory body is suspended by means of pendulum rods on a fastening portion, in particular on a tower top flange. Four or more pendulum rods are preferably proposed. In particular, an even number of pendulum rods is proposed. Through the use of the pendulum rods, it is sought to achieve that the vibratory body is restricted substantially to translational or tilt-free movements. Here, the pendulum rods are preferably formed at both sides with spherical joint heads, that is to say with ball joints, or with a cardanic suspension. It is achieved in this way that the pendulum movement is made possible in all horizontal directions. Here, it is the intention that the joints of the pendulum rods do not influence the direction of the pendulum movement. The pendulum rods are preferably at least approximately as long as the vibratory body is tall. In this way, it is achieved in particular that the pendular movements have no or no significant vertical component. The pendulum rods are preferably each at least three times as long, in particular at least five times as long and preferably at least seven times as long, as a spacing of the vibratory body to the tower wall in the rest state.

Owing to the nature of the suspension of the vibratory body, specifically in particular on multiple pendulum rods, it is the case, after a deflection of the vibratory body, that the weight force also gives rise to a restoring force, which ultimately also at least assists here in returning the vibratory body into its rest position. Correspondingly, the use of restoring springs can be avoided or reduced.

The vibratory body is preferably manufactured from a material with a density higher than water. At the least, it has, overall, a higher density than water. It is proposed in particular that the density is at least twice that of water. Concrete is proposed as a preferred material for this. In particular, the vibratory body is manufactured substantially from concrete, preferably from reinforced concrete. It is however also possible for a receiving body for being filled with concrete to be provided for this purpose. In particular, in this case, it is possible for only concrete to be used or introduced, without the use of reinforced concrete. The stiffness and strength and the provision of suspensions or suspension points can be realized by means of these receiving bodies.

An advantage in the use of a receiving body together with concrete is also that liquid concrete that has not yet set is pumpable, and it is thus possible for the vibratory body to be installed as an empty receiving body in the erected tower and for desired concrete to then be pumped up.

In one embodiment, however, provision is made for the vibratory body to be provided as a prefabricated element, in particular as a prefabricated concrete part.

The tower is preferably characterized in that multiple coupling elements are arranged between the vibratory body and the tower wall and are distributed in a circumferential direction around the vibratory body. Each of said coupling elements is fastened to the vibratory body and to the tower wall. In this way, a mechanical coupling is realized between the vibratory body and the tower wall, wherein the coupling permits, but influences, a horizontal relative movement between vibratory body and tower wall.

The vibratory body, including the suspension thereof, hereby forms, together with the coupling elements, the vibratory apparatus for influencing the vibration of the tower. Said vibratory apparatus may in this case preferably be formed as an absorber system which can reduce, or in the optimum case even eliminate, vibrations that occur. Said vibratory apparatus, in particular the absorber system, is set or readjusted to the expected vibrations of the tower, in particular also the frequency, through selection of the vibratory body and of the coupling elements. To influence this, it is correspondingly possible to set or select the mass of the vibratory body, the spring stiffness of the coupling elements, the damping characteristics, in particular damping constant, of a damping portion of each coupling element, and the number of coupling elements, position of the coupling elements, and length of the pendulum rods.

Use is preferably made of coupling elements according to at least one embodiment of the coupling elements as described above. It is thus possible for the advantages described with regard to the coupling elements to be correspondingly used here for the variation or damping or absorption of vibrations of the wind turbine tower.

The coupling elements are preferably arranged above and furthermore or alternatively below the vibratory body. In this way, it is in particular also possible for use to be made of coupling elements which have an extent much greater than that of an intermediate space that is present between the vibratory body and the tower wall. It is particularly preferable here for a or the central portion of each coupling element to be fastened to an upper edge or lower edge of the vibratory body, whereas one of the two anchor portions is fastened to the tower wall and the remaining, other anchor portion projects freely into the interior space of the tower, in particular also into a region above the inner cavity of the vibratory body. Here, the entire construction, that is to say the vibratory body installed in the tower with the coupling elements, nevertheless still leaves sufficient space free in the tower interior in order to use the tower interior region for various technical equipment, but in particular to guide electrical lines, in particular cable harnesses, therein.

The vibratory body preferably has a center of mass, and the vibratory body is suspended at such a height in the tower that the center of mass is situated in an upper half, in particular in an upper three-fifths, of the tower. Furthermore or alternatively, provision is made for the vibratory body to be suspended on a fastening portion or multiple fastening portions which is or are arranged on the tower top flange. An arrangement in the vicinity of the tower top flange may also be considered, which is however to be understood to mean that the fastening is realized possibly not directly to the tower top flange but in the immediate vicinity of the tower top flange. For example, on the final tower segment, the fastening portion may be provided as an encircling fastening flange, with an intermediate ring thereon, and the tower top flange on the latter. A fastening of the fastening portions to the tower top flange is however preferably proposed.

Firstly, said vertical position of the center of mass of the vibratory body is provided at a position at which a first natural frequency has a large deflection, the eigenmode of which thus exhibits a large deflection there. Here, it is also possible for different eigenmodes to arise during the bending vibration of the tower.

The vibratory apparatus is preferably designed to dampen a vibration of the tower with regard to the natural frequencies thereof. A corresponding design may, as described above, be set by means of the mass of the vibratory body, the spring function of the coupling elements, the damping function of the coupling elements, the number of coupling elements, pendulum rod lengths, and also the vertical position of the center of mass of the vibratory body.

Furthermore, a vibratory apparatus is proposed which is designed for use in a tower of a wind turbine for the purposes of influencing a vibration of the tower. Said vibratory apparatus has a vibratory body which can be suspended in the tower so as to be spaced apart from the tower wall, and said vibratory apparatus has at least one coupling element for fastening between the vibratory body and the tower wall in order to thus influence a relative movement between the vibratory body and the tower wall. For this purpose, it is proposed that the vibratory body is formed so as to be hollow along a vertical central axis and, furthermore or alternatively, each coupling element has a spring function, and the spring function is substantially identical for a first and a second movement direction which are directed oppositely to one another. In particular, it is possible for at least four, in particular exactly four or exactly six or exactly eight, coupling elements to be provided, which are distributed uniformly around the vibratory body in a circumferential direction, preferably above the vibratory body and/or below the vibratory body.

Said vibratory apparatus is preferably designed for use in a tower according to an embodiment described above in this regard. In particular, the vibratory apparatus has at least one feature as has been described in conjunction with the description of the embodiments of the tower in conjunction with the vibratory apparatus.

Furthermore or alternatively, the vibratory apparatus has at least one coupling element as has been described in accordance with at least one above-described embodiment relating to a coupling element.

Also proposed is a method for influencing a tower vibration or a tower natural frequency of a tower of a wind turbine, wherein said tower has a vibratory apparatus with multiple coupling elements. Said method proposes detecting a tower natural frequency, then predefining a desired absorber frequency, and thereupon setting the coupling elements to the absorber frequency. These steps of detecting, predefining and setting are preferably repeated in order to improve the characteristics.

Alternatively, a tower vibration amplitude is detected, a desired maximum tower vibration amplitude is predefined, and the coupling elements are set such that the tower vibration amplitude remains below the desired maximum tower vibration amplitude.

Here, consideration is in particular also given to a variation of the damping function in order to reduce the vibration amplitude. In this case, too, the steps of detecting, predefining and setting may be repeated. In particular, it is proposed that the tower natural frequency or the tower vibration amplitude be continuously detected and that, in a manner dependent on this, a decision be taken as regards whether or not the further steps are necessary. In particular, consideration is also given to setting the coupling elements once again, which may thus also be referred to as readjustment, without predefining a desired absorber natural frequency or a new desired maximum tower vibration amplitude. Consideration is however also given not only to readjusting the setting of the coupling elements but also to readjusting the desired absorber natural frequency and/or the desired maximum tower vibration amplitude, that is to say varying the setpoint values for these.

Also proposed is a wind turbine which has a vibratory apparatus with coupling elements according to an above-described embodiment of the coupling elements, has a tower according to an above-described embodiment of a tower, has a vibratory apparatus according to an above-described embodiment of a vibratory device, and furthermore or alternatively has a control device, which is designed for carrying out a method described above, according to one embodiment, for the purposes of influencing a tower vibration.

It is also proposed that the method for influencing a tower vibration is used together with a vibratory apparatus and coupling elements according to an embodiment described above with regard to coupling elements, that said method is used together with a tower according to an above-described embodiment relating to a tower, and that said method is furthermore or alternatively used together with a vibratory apparatus according to an above-described embodiment relating to a vibratory apparatus. It is thus possible for the advantages of the respectively described embodiments to be utilized for the proposed method and the proposed wind turbine.

As a result, in particular, a solution is proposed which, in a simple and at the same time efficient manner, varies a vibration of a tower of a wind turbine or a vibration of a wind turbine as a whole, which is noticeable in particular in the tower. The variation may relate to the frequency characteristics or the amplitude. Here, said solution is configured in particular as a passive solution, which can influence at least one characteristic of the tower or of the wind turbine with regard to a vibration characteristic. In this way, it is possible in particular to achieve a variation of the system characteristics of the tower or of the wind turbine with regard to the vibration characteristics. Here, the solution is efficient and is configured such that, in particular, the tower interior is also not unduly obstructed. Adjustability may also be provided, by means of which it is in particular also possible for the influencing of the vibrations to be set and adapted in situ.

### BRIEF DESCRIPTION OF THE SEVERAL VIEWS OF THE DRAWINGS

The invention will now be discussed in more detail below by way of example on the basis of exemplary embodiments and with reference to the appended figures.

FIG. 1 shows a wind turbine in a perspective illustration.

FIG. 2 shows a detail of a wind turbine tower in a sectional view.

FIG. 3 shows a detail of FIG. 2 with further details.

FIG. 4 shows a further detail of FIG. 2 with further details.

FIG. 5 shows a horizontal section through the tower detail as per FIG. 2.

FIG. 6 shows a coupling element in a lateral sectional view.

### DETAILED DESCRIPTION

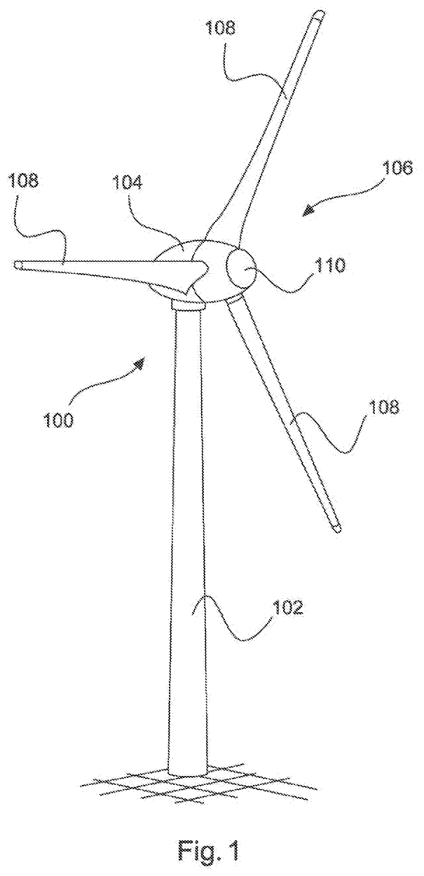

FIG. 1 shows a wind turbine 100 having a tower 102 and a nacelle 104. On the nacelle 104, there is arranged a rotor 106 with three rotor blades 108 and a spinner 110, which is part of a hub. The rotor 106 is, during operation, set in rotational motion by the wind, and thus drives a generator in the nacelle 104.

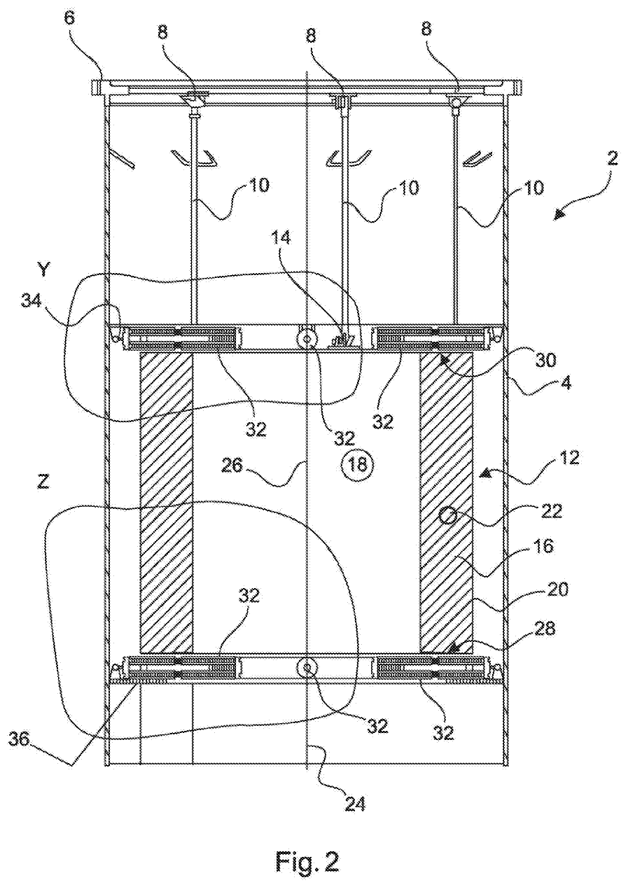

FIG. 2 shows a tower portion 2 with a tower wall 4, which may also vary in nature and thickness over the height. The tower portion 2 is closed off by means of a tower top flange 6. The tower top flange 6 is formed as an encircling flange and is provided in particular for holding an azimuth bearing for the rotatable mounting of a nacelle.

Attached to the tower top flange 6 are suspension fasteners 8, which each pivotably bear a pendulum rod 10, and wherein a vibratory body 12 is suspended on the pendulum rods 10. For this purpose, the pendulum rods 10 are likewise pivotably fastened, by means of vibratory body fasteners 14, to the vibratory body 12.

The pendulum rods 10 thus function as a suspension for the vibratory body 12. The suspension fasteners 8 may in this case also be referred to as tower top flange fasteners.

The vibratory body 12 can thus, owing to the relatively long pendulum rods 10, vibrate substantially in a horizontal plane in all directions. Aside from longitudinal vibrations in various directions, consideration is also given to circulating movements, that is to say a superposition of multiple longitudinal vibrations.

The vibratory body 12 is formed substantially by a vibratory body shell 16, which surrounds a vibratory body cavity 18. The vibratory body shell 16 may, as shown in FIG. 2 and some of the other figures, be formed as a vibratory body container 20 with container filling 22.

In FIG. 2, there is also shown a tower central axis 24, which thus forms a central axis for the tower and thus the tower portion 2. Here, said tower central axis coincides with a body central axis 26, which forms a vertical central axis for the vibratory body 12.

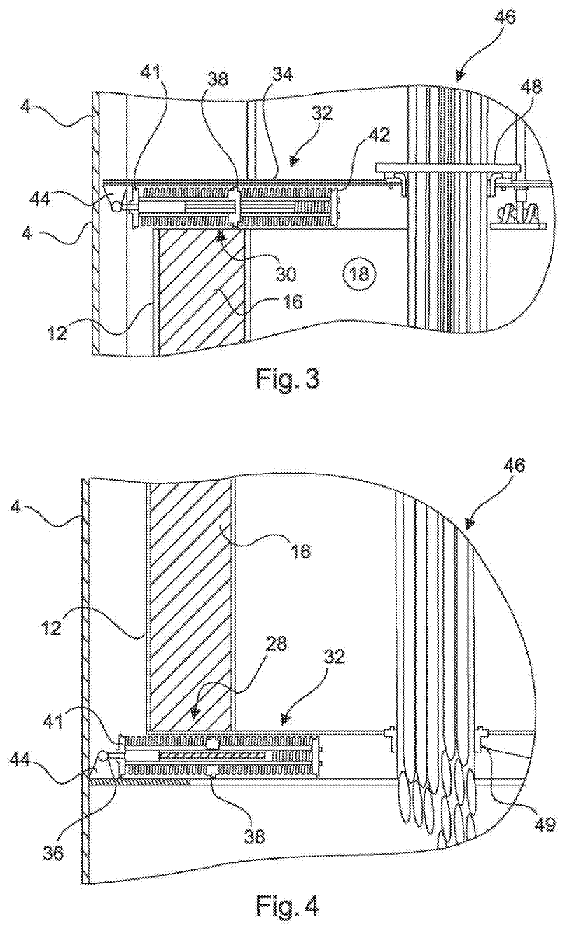

The vibratory body 12 may be coupled, at a lower edge 28 and an upper edge 30, by means of coupling elements 32 to the tower wall 4. Details of the coupling in the region of the upper edge 30 are shown in FIG. 3, and details of the coupling in the region of the lower edge 28 are shown in FIG. 4.

The fastening of each coupling element 32 to the tower wall 4 is realized, in the case of the coupling elements 32 fastened at the upper edge 30, by means of a fastener to a tower bulkhead 34. A tower bulkhead 34 of said type is basically used for creating, in the wind turbine tower, a platform on which work can be performed, or on which breaks can be taken. Such a tower bulkhead 34 also prevents anything from being able to fall down from the nacelle 104 into the tower. The tower bulkhead is fastened uniformly in a circumferential direction to the tower wall 4 and may in this case also form a stiffening ring or a stiffening surface for the tower. By means of the fastening of the coupling elements 32 to the tower bulkhead 34, a punctiform introduction of force into the tower wall can be avoided. Instead, an introduction of force takes place into the tower bulkhead 34, which can in turn transmit said force, uniformly in the circumferential direction, to the tower wall 4 of the tower portion 2.

In the region of the lower edge 28, the coupling elements 32 are fastened by means of a stiffening ring 36 to the tower wall 4. Said connection by means of the stiffening ring 36 to the tower wall 4 also prevents a punctiform introduction of forces via the respective coupling element 32 into the tower wall 4. If the vibratory body 12 vibrates relative to the tower portion 2, it therefore also vibrates relative to the tower bulkhead 34 and the stiffening ring 36. Since the vibratory body 12 is situated below the tower bulkhead 34, the pendulum rods 10 are led through corresponding openings through the tower bulkhead 34.

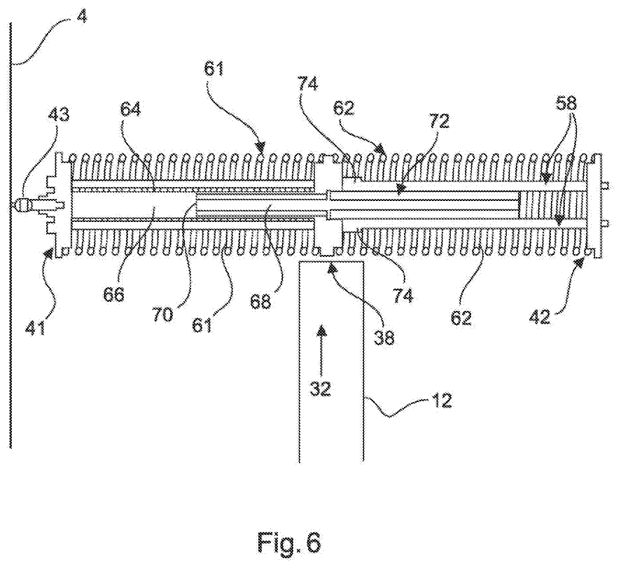

FIG. 3 shows, in an enlarged detail, the coupling of the vibratory body 12 by means of coupling elements 32, of which only one is illustrated in FIG. 3, to the tower wall 4. The coupling element 32, which is shown in a more detailed illustration in FIG. 6, is fastened by means of a central portion 38 to the upper edge 30 of the vibratory body 12 or of the vibratory body casing 16 thereof.

The central portion 38 is arranged in resiliently elastic fashion between a first armature portion 41 and a second anchor portion 42. The first and the second anchor portion 41, 42 are rigidly connected to one another. The first anchor portion 41 is fastened by means of a fastening angle bracket 44 to the tower bulkhead 34.

In the event of a vibratory movement of the vibratory body 12 relative to the tower wall 4, an introduction of force thus takes place from the vibratory body 12 via the central portion 38 into the coupling element 32, which transmits this resiliently elastically to the first anchor portion 41, and via this and via the fastening angle bracket 44 to the tower bulkhead 34 and thus the tower wall 4. The vibratory body 12 is thus coupled resiliently elastically to the tower wall 4.

Furthermore, there is also indicated in FIG. 3 a cable harness 46 which can be led through the tower bulkhead 34 and in particular also through the interior cavity, specifically the vibratory body cavity 18 of the vibratory body 12. For this purpose, in the tower bulkhead 34, there may be provided an opening in which the cable harness 46 is led through a cable guide 48.

The construction in the region of the lower edge 28 is shown in FIG. 4 and is very similar to the construction in the region of the upper edge 30. In the region of the lower edge 28, too, the vibratory body 12 is coupled to the central portion 38 of the coupling element 32. The coupling element 32 is in turn coupled via the first anchor portion 41 and via a fastening angle bracket 44 to the stiffening ring 36. The stiffening ring 36 may also be referred to as a buckling resistor.

The vibratory body 12 may also have a cable guide 49 at its bottom side.

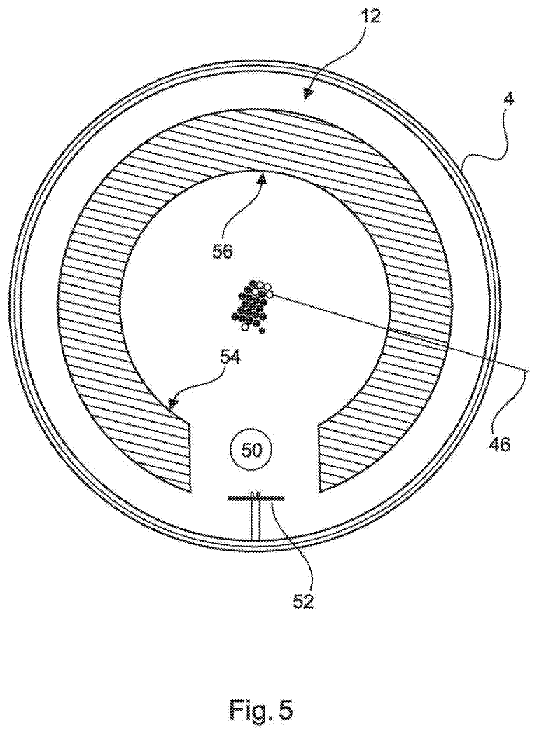

The plan view in FIG. 5 shows in particular the shape of the vibratory body 12. It has substantially a circular cylindrical shape which is equipped with a vertical aperture 50. Said vertical aperture 50 serves for creating space in the region of a tower ladder 52. The vibratory body 12 can thus, owing to its relatively large outer diameter, have a large volume and thus a high mass. The interior space of the tower thus nevertheless remains usable, and in particular, an ascent via the tower ladder 52 is thereby not impeded.

In order, despite the aperture 50, to realize a central center of mass of the vibratory body 12, the wall thickness of the vibratory body 12 may be formed so as to be slightly greater in the region of the tower ladder 52 than at a region averted from the tower ladder 52. For explanatory purposes, a region 54 close to the tower ladder 52 and a region 56 remote from the tower ladder 52 are indicated. Mass compensation can thus be realized by virtue of a particularly great wall thickness being provided in the region 54 close to the tower ladder, whereas as small a wall thickness as possible is provided in the region 56 remote from the tower ladder.

FIG. 6 shows, in a lateral sectional view, the coupling element 32 with further details. The first and second anchor portions 41, 42 are fixedly connected to one another by means of tension rods 58. The central portion 38 can be moved relative to the two anchor portions 41 and 42. For this purpose, the tension rods 58 may also form a guide for the central portion 38 for such a movement. Furthermore, each anchor portion may also be referred to as end plate, and the central portion 38 may be referred to as central plate.

Between the central portion 38 and the first anchor portion 41, there is arranged a first spring 61, which forms a first spring portion. Between the central portion 38 and the second anchor portion 42, there is arranged a second spring 62, which forms a second spring portion.

Said two springs 61 and 62 together form a common spring means of the coupling element 32. The two springs 61 and 62 are substantially identical, and the two springs 61 and 62 are prestressed. FIG. 6 thus shows a rest position of the coupling element 32. The two springs 61 and 62 are formed as helical springs and are received in each case in a receiving portion on the first or second anchor portion 41, 42 and the central portion 38.

The statement that the two springs 61 and 62 are prestressed means that they are already compressed in the position shown in FIG. 6. Both springs 61 and 62 therefore already exert a force in each case from the first and second anchor portion 41 and 42 respectively on the central portion 38, or vice versa, wherein said two forces however cancel one another out in the rest position shown. Owing to this prestress, a movement of the central portion 38 along the tension rods 58 experiences substantially a linear relationship between deflection and spring force. As a result of movement in one direction, for example toward the first anchor portion 41, the spring force of the first spring 61 increases, whereas the spring force of the second spring 62 decreases. If the central portion 38 moves from the rest position shown in the opposite direction, the same effect arises, wherein the force imparted by the second spring 62 increases, and that imparted by the first spring 61 decreases. The resultant force on the central portion 38 and thus also on the vibratory body 12 arises from the difference between the spring forces of the two springs 61 and 62. The force relationships are thus equal in both deflection directions.

Furthermore, a damping portion 64 is provided, which substantially has a damping cylinder 66 in which a damping piston 68 moves. The damping piston 68 has a resistance plunger 70, the movement of which in the damping cylinder 66 is braked by virtue of the fact that a fluid in the damping cylinder 66 must pass said resistance plunger 70. The damping action, that is to say the movement-speed-dependent resistance, is in this case substantially independent of the movement direction of the damping piston 68 and thus of the movement direction of the resistance plunger 70.

The coupling of the damping piston 68 and thus of the resistance plunger 70 is realized via a cladding tube 72, which is fastened to the central portion 38 and which thus, during a movement of the central portion 38, moves together with the latter and in the process also concomitantly drives the damping piston 68. For the guidance of the central portion 38, guide cylinders 74 are furthermore provided, which guide the central portion 38 on the tension rods 58.

It can also be seen that the coupling element is designed such that the movement amplitude between the vibratory body 12 and the tower wall 4 and thus between the central portion 38 and the first anchor portion 41 is at most half as great as the spacing between the first anchor portion 41 and the central portion 38 in the rest position thereof. It is thus also achieved that the two springs 61 and 62 are not moved as far as their maximum deflection limit, whereby, for the provided movement range, it is substantially possible to achieve linearity in the operating range.

Furthermore, FIG. 6 illustrates the attachment of the coupling element 32, and accordingly, the coupling element 32 is fastened by way of its central portion 38 to a top side of a vibratory body 12. By means of its anchor portion 41, said coupling element is fastened via a joint head 43 to the tower wall 4 of the tower whose vibration is to be dampened. A vibratory movement of the tower leads in this case to a relative movement between the tower wall 4 and the vibratory body 12 and thus to a relative movement between the anchor portion 41 and the central portion 38. A small vertical movement of the vibratory body 12 may also arise, which can be allowed for by means of the joint head 43.

It is pointed out that, for the sake of clarity, the same reference designations have been used for similar but possibly non-identical elements. This applies to the description of all of the figures. A solution has thus been created and proposed which can influence or at least dampen the natural frequencies of the tower and which thus creates greater freedom in designing a new tower. Insofar as vibration dampers have been dispensed with, it is specifically necessary in designing new towers to ensure that the natural frequencies of the bending vibration of the tower do not coincide with or lie close to the excitation frequencies from the operation of the installation, in order to avoid damaging resonance.

In designing a tower with vibration dampers, there is no need to take into consideration the position of the natural frequency to which the absorber is tuned, whereby greater freedom in the design process can be achieved.

The vibratory body, which is designed as a hollow cylinder and which can also be referred to as absorber mass, allows cables to be led through centrally in the tower. Through the use of the greatest possible absorber mass radius, the structural space is utilized optimally, or at least highly effectively, in terms of volume, and it is thus possible for a large mass to be accommodated in the vibratory body. A star-shaped arrangement of the spring-damper elements, that is to say a star-shaped arrangement of the coupling elements, permits an omnidirectional, that is to say virtually direction-independent, action of the vibration damper, that is to say of the coupling element.

The suspension of the vibratory body on the discussed pendulum rods likewise permits a virtually omnidirectional action and forces a tilt-free movement of the vibratory body, that is to say of the absorber mass. The directional independence of the action increases with the number of vibration dampers, that is to say of coupling elements.

1. A coupling element designed for fastening between a vibratory body and a tower wall of a tower of a wind turbine in order to influence a relative movement between the vibratory body and the tower wall to thereby influence a vibration characteristic of the tower, the coupling element comprising:
a first fastening portion for fastening to the vibratory body; and
a second fastening portion for fastening to the tower wall and producing a mechanical coupling between the vibratory body and the tower wall via the coupling element, wherein:
the coupling permits a relative movement between vibratory body and tower wall,
the relative movement has a first movement direction in which the first and the second fastening portion move toward one another, and
the relative movement has a second movement direction in which the first and the second fastening portion move away from one another,
a spring means for resiliently elastic coupling between the first and second fastening portions, wherein the resiliently elastic coupling is described by a spring function, and wherein the spring means has at least one characteristic of the following characteristics:
the spring function is substantially identical for the first and second movement directions,
a movement in the first movement direction in the spring means leads to a compression of a first spring portion and to an extension of a second spring portion, and
a movement in the second movement direction in the spring means leads to an extension of the first spring portion and to a compression of the second spring portion to thereby equalize the spring function for the first and second movement directions with one another.

2. The coupling element as claimed in claim 1, wherein the coupling element is formed as a spring-damper element and has a damping portion for coupling with damping action between the first and second fastening portions,
wherein the coupling with damping action is described by a damping function, and
wherein the damping function is substantially equal for the first and second movement directions.

3. The coupling element as claimed in claim 2, wherein at least one of: the spring function is linear or the damping function is linear.

4. The coupling element as claimed in claim 1 further comprising:
a first anchor portion and a second anchor portion that are connected to one another, and
a central portion arranged between the first and second anchor portions and is movable relative to the first and second anchor portions, wherein:
the first or second anchor portions are connected to the second fastening portion, and
the central portion is connected to the first fastening portion, such that the relative movement corresponds to a movement of the central portion between the first and second anchor portions.

5. The coupling element as claimed in claim 4, wherein the spring means comprises:
a first spring arranged between the central portion and the first anchor portion, and
a second spring arranged between the central portion and the second anchor portion, wherein the first spring forms the first spring portion and the second spring forms the second spring portion.

6. The coupling element as claimed in claim 5, wherein the first and second springs are prestressed such that neither of the first or the second springs reaches or overshoots a relaxed state during the movement in the first or second movement directions.

7. The coupling element as claimed in claim 6, wherein a spacing between the first and second anchor portions is adjustable in order to adjust the prestress.

8. A tower of a wind turbine comprising:
a tower central axis,
a tower wall, and
a vibratory apparatus for influencing a vibration of the tower, wherein the vibratory apparatus comprises:
has a vibratory body suspended in the tower so as to be spaced apart from the tower wall, and
at least one coupling element fastened between the vibratory body and the tower wall, wherein the at least one coupling element is configured to influence a relative movement between the vibratory body and the tower wall, wherein the vibratory body is hollow along a vertical body central axis.

9. The tower as claimed in claim 8, wherein the vibratory body has a substantially hollow truncated cone shape or substantially hollow cylinder shape with a vertical aperture, wherein a tower ladder is arranged on the tower wall at the vertical aperture and configured to provide access for service personnel to climb up and down in the tower along the tower ladder and, in so doing, allowed to pass through the vibratory body in a region of the vertical aperture.

10. The tower as claimed in claim or 8, wherein the vibratory body has a vibratory body wall that encircles the vertical body central axis, the vibratory body wall having a wall thickness, wherein the wall thickness varies in a circumferential direction such that the vibratory body has a center of gravity in the vertical body central axis, wherein the vertical body central axis corresponds to a geometrical center of the vibratory body or coincides, in the rest state of the vibratory body, with the tower central axis.

11. The tower as claimed in claim 8, wherein the vibratory body is suspended so as to be spaced apart from the tower wall centrally with a mean wall spacing, and wherein the mean wall spacing is less than one quarter of a tower inner diameter.

12. The tower as claimed in claim 8, wherein the vibratory body is suspended by a plurality of pendulum rods on a fastening portion on a tower top flange, wherein three or more pendulum rods of the plurality of pendulum rods are provided such that the vibratory body is restricted to translational or tilt-free movements, wherein the plurality of pendulum rods are equipped at both sides with spherical joint heads or a cardanic suspension, such that a movement in horizontal directions is possible.

13. The tower as claimed in claim 8, wherein the vibratory body is produced from a material with a density that is higher than or equal to a density of water wherein the vibratory body includes concrete.

14. The tower as claimed in claim 8, wherein the at least one coupling element is a plurality of coupling elements arranged between the vibratory body and the tower wall and distributed in a circumferential direction around the vibratory body, and wherein each of the plurality of coupling elements are fastened to the vibratory body and to the tower wall to produce a mechanical coupling between the vibratory body and the tower wall, wherein the coupling permits a horizontal relative movement between vibratory body and tower wall.

15. The tower as claimed in claim 8, wherein the plurality of coupling elements are an even number of coupling elements.

16. The tower as claimed in claim 8, wherein the plurality of coupling elements are arranged above or below the vibratory body.

17. The tower as claimed in claim 8, wherein the vibratory body has a center of mass, and wherein the vibratory body is suspended at such a height in the tower that the center of mass is situated in an upper half of the tower.

18. A vibratory apparatus designed for use in a tower of a wind turbine for the purposes of influencing a vibration of the tower, wherein the vibratory apparatus comprises:
a vibratory body configured to be suspended in the tower so as to be spaced apart from the tower wall, and
at least one coupling element for fastening the vibratory body to the tower wall, the at least one coupling element being configured to influence a relative movement between the vibratory body and the tower wall, wherein:
the vibratory body is formed so as to be hollow along a vertical central axis, and
each coupling element has a spring function, and the spring function is substantially identical for a first movement direction and a second movement direction which is opposite to the first movement direction.

19. The vibratory apparatus as claimed in claim 18, wherein the vibratory apparatus is fastened to a tower wall of a tower of a wind turbine, wherein the vibratory apparatus includes a plurality of coupling elements that fasten the vibratory body to the tower wall.

20. A method comprising:
influencing a tower vibration or a natural frequency of a tower of a wind turbine, wherein the tower has a vibratory apparatus with a plurality of coupling elements, wherein the influencing comprises:
detecting a tower natural frequency or a tower vibration amplitude,
pre-defining a desired absorber natural frequency or a desired maximum tower vibration amplitude, and
setting the plurality of coupling elements to the absorber natural frequency or such that the tower vibration amplitude remains below the desired maximum tower vibration amplitude.

21. (canceled)

22. A wind turbine comprising:
a nacelle;
an aerodynamic rotor; and
a tower have a tower central axis, a tower wall and the vibratory apparatus as claimed in claim 18 coupled to the tower wall.

23. A vibratory body of the vibratory apparatus as claimed in claim 18.
